(19) United States
(12) Patent Application Publication
(10) Pub. No.: US 2026/0219895 A1
(43) Pub. Date: Jul. 30, 2026

(54) INFORMATION PROCESSING APPARATUS

(71) Applicant: NEC Corporation, Tokyo (JP)

(72) Inventor: Michimasa IRIE, Tokyo (JP)

(73) Assignee: NEC Corporation, Tokyo (JP)

(21) Appl. No.: 19/451,045

(22) Filed: Jan. 16, 2026

(30) Foreign Application Priority Data
Jan. 29, 2025 (JP) 2025-013359

(51) Int. Cl. G06F 9/445; G06F 11/00

(52) U.S. Cl. CPC G06F 9/44505; G06F 11/006; G06F 2201/865

(57) ABSTRACT

An information processing apparatus includes: an error message acquiring unit that acquires an error message from an IT (Information Technology) system; a configuration information acquiring unit that acquires configuration information indicating a configuration of the IT system; a state information acquiring unit that acquires state information indicating a state of a device configuring the IT system; and a partial configuration information acquiring unit that acquires partial configuration information indicating part of the configuration of the IT system indicated by the configuration information in accordance with the error message, the configuration information, and the state information.

### INCORPORATION BY REFERENCE

This application is based upon and claims the benefit of priority from Japanese patent application No. 2025-013359, filed on January 29, 2025, the disclosure of which is incorporated herein in its entirety by reference.

### TECHNICAL FIELD

The present disclosure relates to an information processing apparatus, an information processing method, and a recording medium.

### BACKGROUND ART

A technique used to identify candidates for failure cause in IT systems and the like is known.

For example, Patent Literature 1 describes a failure location estimation system that has a related class applying unit, an investigation scope limiting unit, and a failure occurrence location candidate estimating unit. According to Patent Literature 1, the related class applying unit refers to configuration information, related class information, and related class application rule, and applies a related class with respect to a relation between components included by the configuration information. Further, the investigation scope limiting unit obtains an investigation scope limitation tree with reference to investigation details in which the types of anomalies occurring in components are associated with related classes and directions to be traced at the time of investigation of the causes of the anomalies. After that, the failure occurrence location candidate estimating unit estimates a candidate for a location where a failure that is the cause of the anomaly has occurred, based on the appearance frequency of the components in the investigation scope limitation tree.

Patent Literature 1: Japanese Unexamined Patent Application Publication No. JP-A 2011-138405

### SUMMARY

The configuration of an IT system has been complicated due to virtualization, scaling up, and the like. Therefore, for example, at a time when a failure occurs in an IT system, it may be desirable to narrow down the scope of investigation and then identify candidates for failure cause. However, in the case of narrowing down the scope of investigation based on rules as described in Patent Literature 1, there is a case where the scope of investigation cannot necessarily be narrowed down appropriately. As such, there has been a problem that it may be difficult to appropriately narrow down when identifying candidates for failure cause.

Accordingly, an object of the present disclosure is to provide an information processing apparatus, an information processing method, and a program that can solve the abovementioned problem.

In order to achieve the object, an information processing apparatus in the present disclosure includes: an error message acquiring unit that acquires an error message from an IT (Information Technology) system; a configuration information acquiring unit that acquires configuration information indicating a configuration of the IT system; a state information acquiring unit that acquires state information indicating a state of a device configuring the IT system; and a partial configuration information acquiring unit that acquires partial configuration information indicating part of the configuration of the IT system indicated by the configuration information in accordance with the error message, the configuration information, and the state information.

Further, an information processing method in the present disclosure is an information processing method by an information processing method, and includes: acquiring an error message from an IT (Information Technology) system; acquiring configuration information indicating a configuration of the IT system; acquiring state information indicating a state of a device configuring the IT system; and acquiring partial configuration information indicating part of the configuration of the IT system indicated by the configuration information in accordance with the error message, the configuration information, and the state information.

Further, a recording medium in the present disclosure is a non-transitory computer-readable recording medium with a program recorded thereon, and the program includes instructions for causing an information processing apparatus to enable processes to: acquire an error message from an IT (Information Technology) system; acquire configuration information indicating a configuration of the IT system; acquire state information indicating a state of a device configuring the IT system; and acquire partial configuration information indicating part of the configuration of the IT system indicated by the configuration information in accordance with the error message, the configuration information, and the state information.

According to the configurations as described above, it is possible to appropriately narrow down the scope of investigation, for example, when identifying candidates for failure cause.

### BRIEF DESCRIPTION OF THE DRAWINGS

FIG. 1 is a diagram showing an example of a configuration of a failure cause identification system in a first example embodiment of the present disclosure;

FIG. 2 is a diagram showing an example of a configuration of a failure cause identification apparatus;

FIG. 3 is a diagram showing an example of information included in system configuration information;

FIG. 4 is a diagram showing an example of information included in a question sentence generated by a first question sentence generating unit;

FIG. 5 is a diagram showing an example of information included in a question generated by a second question sentence generating unit;

FIG. 6 is a diagram showing an example of candidate information acquired by a second question responding unit;

FIG. 7 is a flowchart showing an example of operation of the failure cause identification apparatus;

FIG. 8 is a diagram for describing an example of an effect of the present disclosure;

FIG. 9 is a diagram showing an example of configuration state information included in a generated first question sentence;

FIG. 10 is a diagram showing an example of output acquired from LLM using the first question sentence shown in FIG. 9;

FIG. 11 is a diagram showing an example of a second question sentence generated using partial configuration information shown in FIG. 10;

FIG. 12 is a diagram showing an example of candidate information acquired using the second question sentence illustrated in FIG. 11;

FIG. 13 is a diagram showing an example of processing by a state information acquiring unit in a second example embodiment of the present disclosure;

FIG. 14 is a block diagram showing an example of a configuration of a failure cause identification apparatus in a third example embodiment of the present disclosure;

FIG. 15 is a diagram showing an example of processing by a feedback unit shown in FIG. 10;

FIG. 16 is a block diagram showing an example of a hardware configuration of an information processing apparatus in a fourth example embodiment of the present disclosure;

FIG. 17 is a block diagram showing an example of a configuration of the information processing apparatus; and

FIG. 18 is a flowchart showing an example of operation of the information processing apparatus.

### EXAMPLE EMBODIMENT

### First Example Embodiment

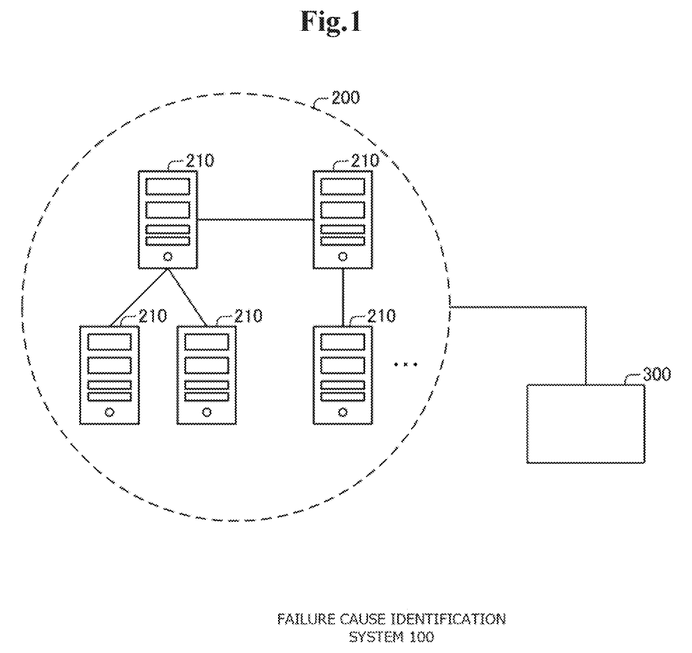

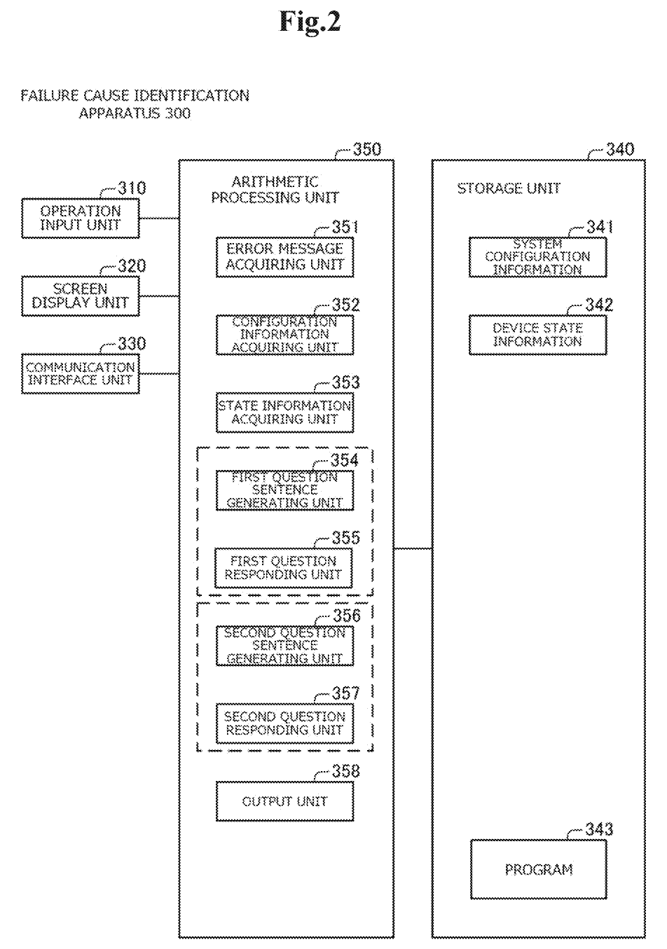

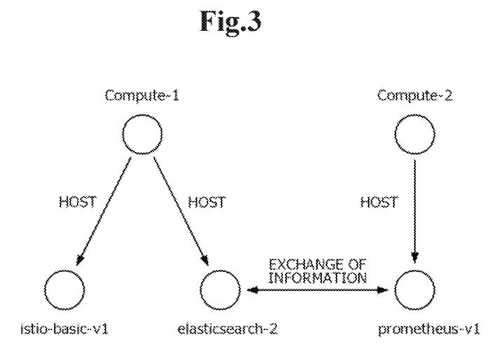

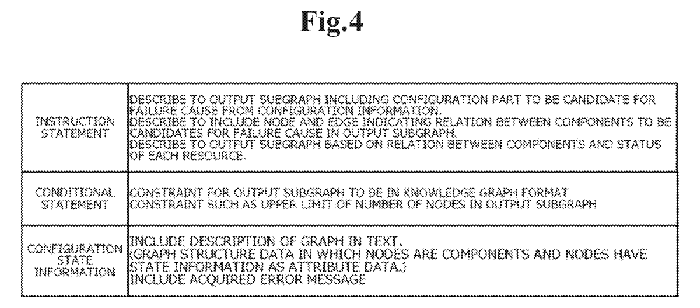

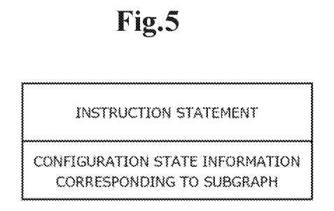

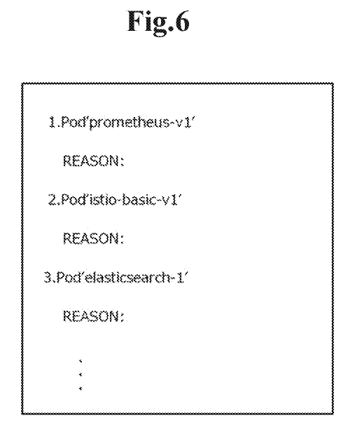

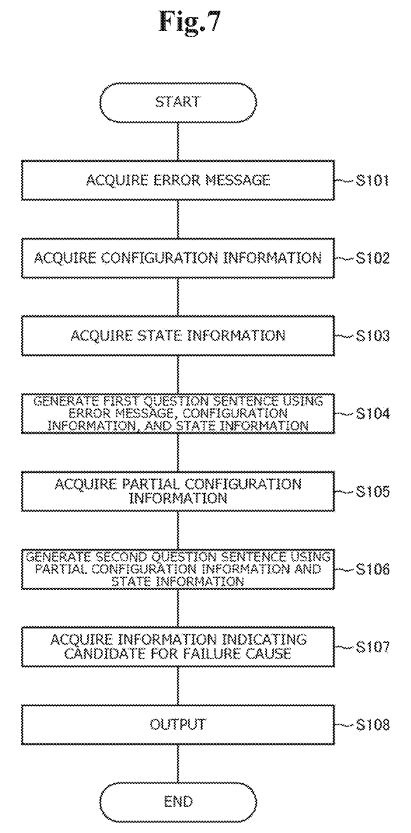

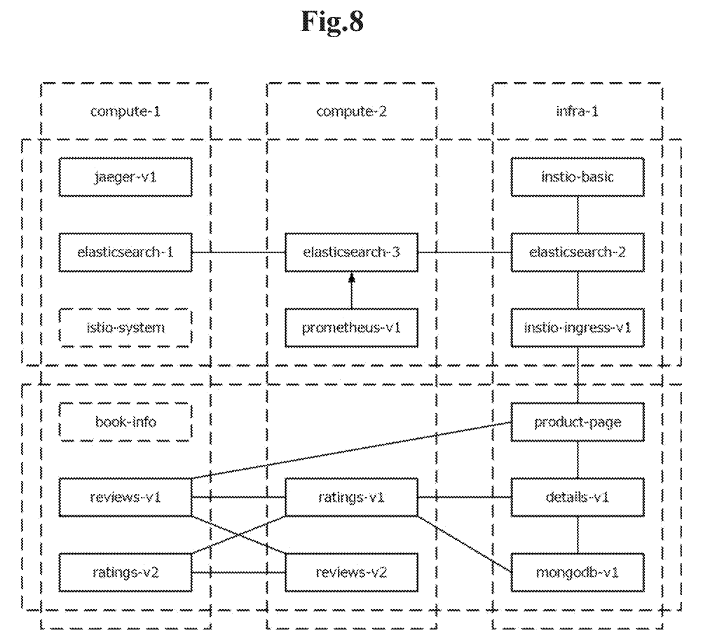

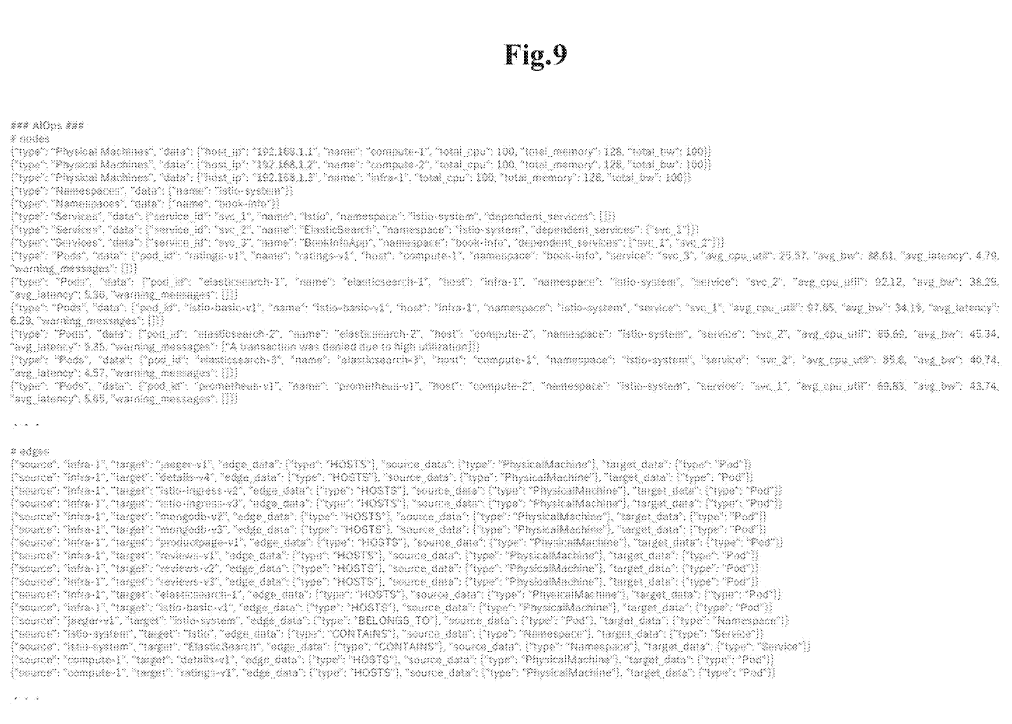

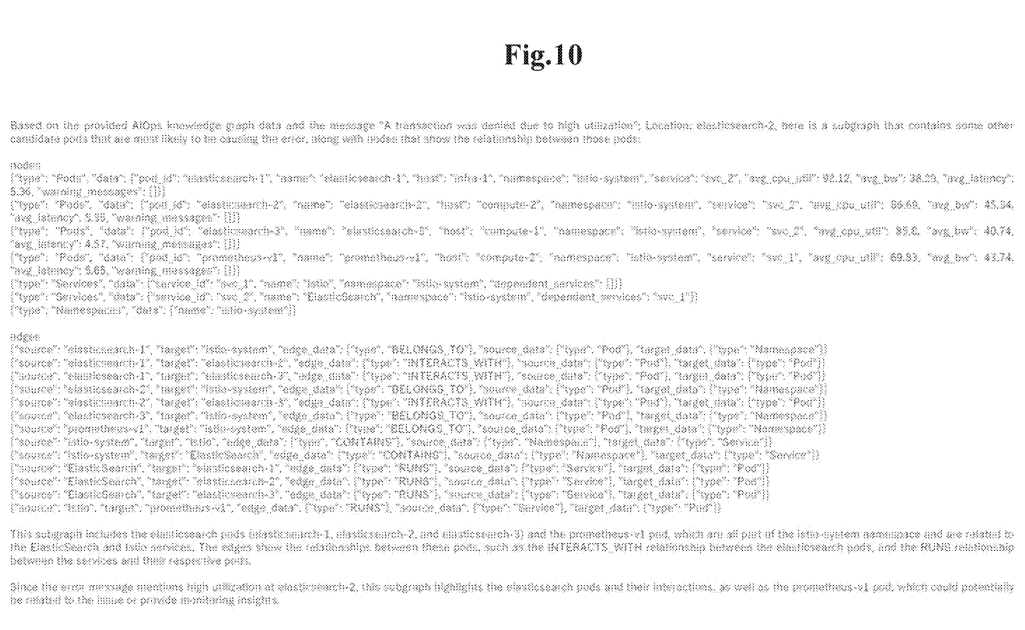

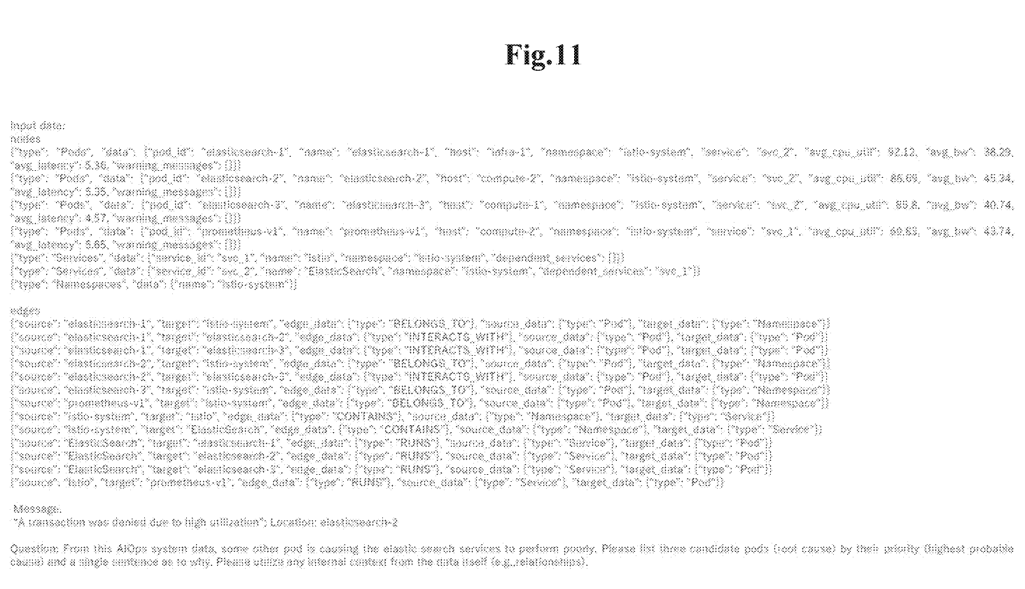

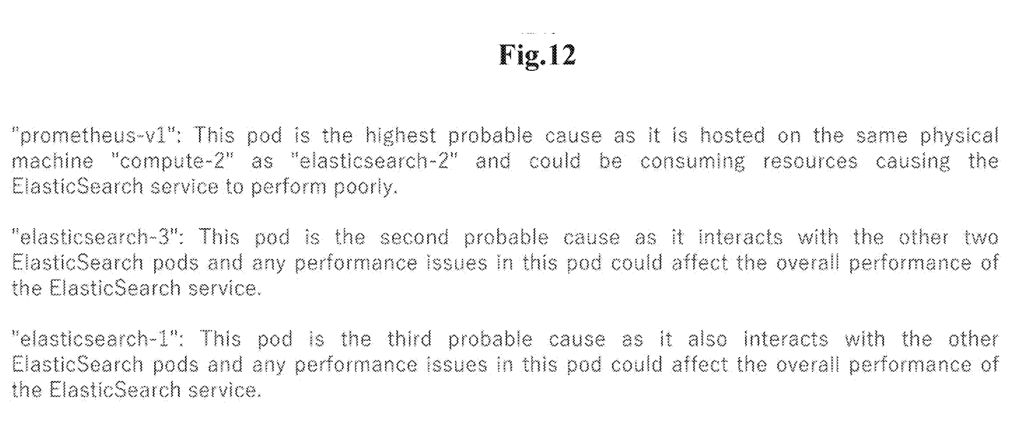

An example of a configuration of a failure cause identification system 100 in the present disclosure will be described with reference to FIGS. 1 to 12. FIG. 1 is a diagram showing an example of a configuration of the failure cause identification system 100. FIG. 2 is a diagram showing an example of a configuration of a failure cause identification apparatus 300. FIG. 3 is a diagram showing an example of information included in system configuration information 341. FIG. 4 is a diagram showing an example of information included in a question sentence generated by a first question sentence generating unit 354. FIG. 5 is a diagram showing an example of information included in a question sentence generated by a second question sentence generating unit 356. FIG. 6 is a diagram showing an example of candidate information acquired by a second question responding unit 357. FIG. 7 is a flowchart showing an example of operation of the failure cause identification apparatus 300. FIG. 8 is a diagram for describing an example of an effect of the present disclosure. FIG. 9 shows an example of configuration state information included in the first question sentence generated in the configuration illustrated in FIG. 8. FIG. 10 shows an example of output acquired from LLM using the first question sentence shown in FIG. 9. FIG. 11 shows an example of a second question sentence generated using partial configuration information shown in FIG. 10. FIG. 12 shows an example of candidate information acquired using the second question sentence illustrated in FIG. 11. In the present disclosure, the drawings may be associated with one or more example embodiments.

The present disclosure describes a failure cause identification system 100 that identifies a device 210 that is a candidate for the cause of an error (failure cause) from among devices 210 included in an IT (Information Technology) system 200, using an error message acquired from the IT system 200. As will be described later, the failure cause identification system 100 in the present disclosure narrows down the scope using the error message and the like, and then identifies the device 210 that is a candidate for error cause from the narrowed scope.

For example, the failure cause identification system 100 acquires an error message from the IT system 200. The error message may include information showing the occurrence time of the error and the details of the error. Moreover, the failure cause identification system 100 acquires configuration information showing the configuration of the IT system 200, and state information showing the states of the devices 210 configuring the IT system 200. Then, the failure cause identification system 100 acquires partial configuration information that includes part of the configuration of the IT system 200 shown by the configuration information, in accordance with the error message, the configuration information, and the state information. For example, the failure cause identification system 100 can acquire the partial configuration information by inputting the error message, the configuration information and the state information into a large-scale language model.

Further, the failure cause identification system 100 identifies information indicating the state of the device 210 corresponding to the configuration indicated by the partial configuration information of the state information with reference to the partial configuration information. Then, the failure cause identification system 100 acquires information indicating a candidate for failure cause in accordance with the partial configuration information and the identified information indicating the state of the device 210. For example, the failure cause identification system 100 can acquire information indicating a candidate for failure cause by inputting the partial configuration information and the identified information indicating the state of the device 210 into a large-scale language model.

FIG. 1 shows an example of a configuration of the failure cause identification system 100. Referring to FIG. 1, the failure cause identification system 100 includes the IT system 200 and a failure cause identification apparatus 300. For example, the failure cause identification apparatus 300 is connected to the IT system 200 via a wired or wireless connection.

The IT system 200 is configured with a plurality of devices 210. Here, the devices 210 configuring the IT system 200 may include not only a physical machine but also a container, a virtual machine, and the like.

Each of the devices 210 configuring the IT system 200 can transmit state information indicating the state of the device 210 to the failure cause identification apparatus 300. The device 210 may transmit, together with the state information, information indicating the time of acquisition of the state information. Here, the state information refers to information indicating the operating status of the device 210. For example, the state information can include metrics data such as a CPU (Central Processing Unit) usage rate, a RAM (Random Access Memory) usage rate, the amount of transferred data, the amount of received data, a disk usage rate, and power consumption. The state information may include part of the metrics data illustrated above, or may include metrics data other than those illustrated above. Moreover, the state information may include a message log and the like, in addition to the metrics data.

The device 210 can transmit the state information at any timing, for example, can transmit the state information at given intervals determined in advance. The device 210 may transmit the state information in response to receiving an instruction from the failure cause identification apparatus 300 or the like.

Further, each of the devices 210 configuring the IT system 200 transmits an error message to the failure cause identification apparatus 300 upon occurrence of an error on the device 210. As an example, assume that an error has occurred on the software executed by the device 210. In this case, the device 210 in which the error has occurred can transmit an error message corresponding to the occurring error to the failure cause identification apparatus 300.

The failure cause identification apparatus 300 is an information processing apparatus that identifies the device 210 that is a candidate for failure cause from among the devices 210 included in the IT system 200, using an error message acquired from the IT system 200. FIG. 2 shows a major configuration example of the failure cause identification apparatus 300. Referring to FIG. 2, the failure cause identification apparatus 300 includes, as major components, an operation input unit 310, a screen display unit 320, a communication interface unit 330, a storage unit 340, and an arithmetic processing unit 350.

FIG. 2 illustrates a case of implementing a function as the failure cause identification apparatus 300 using a single information processing apparatus. However, at least part of the function as the failure cause identification apparatus 300 may be implemented using a plurality of information processing apparatuses, for example, may be implemented on the cloud. Further, the failure cause identification apparatus 300 may not include part of the configuration illustrated above, such as not having the operation input unit 310 or the screen display unit 320, or may have a configuration other than that illustrated above.

The operation input unit 310 is configured with an operation input device such as a keyboard and a mouse. The operation input unit 310 detects an operation by an operator who operates the failure cause identification apparatus 300, and outputs it to the arithmetic processing unit 350.

The screen display unit 320 is configured with a screen display device such as a liquid crystal display and an organic EL (electro-luminescence). The screen display unit 320 can display on a screen a variety of information stored in the storage unit 340 in accordance with an instruction from the arithmetic processing unit 350.

The communication interface unit 330 is configured with a data communication circuit and the like. The communication interface unit 330 performs data communication with an external device such as the devices 210 included in the IT system 200 connected via a communication line.

The storage unit 340 is a storage device such as a hard disk or memory. The storage unit 340 stores processing information and a program 343 necessary for various processing by the arithmetic processing unit 350. The program 343 enables various processing units by being loaded and executed by the arithmetic processing unit 350. The program 343 is loaded in advance from an external device or a recording medium via a data input/output function such as the communication interface unit 330, and stored in the storage unit 340. Main information stored in the storage unit 340 includes, for example, system configuration information 341 and device state information 342. At least part of the information stored in the storage unit 340 may be present in an external database.

The system configuration information 341 includes information indicating the configuration of the IT system 200. The information included in the system configuration information 341 can be acquired in advance by, for example, receiving input using the operation input unit 310 or receiving information from an external device via the communication interface unit 330, and is stored in the storage unit 340.

For example, the system configuration information 341 stores information showing the configuration of the IT system 200 as a knowledge graph. FIG. 3 shows an example of the knowledge graph included in the system configuration information 341. Referring to FIG. 3, the knowledge graph included in the system configuration information 341 represents components such as the devices 210 included in the IT system 200 by nodes. Further, a relation between the components is represented by an edge in the knowledge graph. For example, in the case of FIG. 3, a directed edge is added from "Compute-1" node to "elesticsearch-2" node. Further, the abovementioned relation between the nodes indicates "host". This represents that a container named "elesticsearch-2" is running on a physical machine named "Compute-1". Further, in the case of FIG. 3, a bidirectional edge is added between the "elesticsearch-2" node and a "prometheus-v1" node. Further, the relation between the nodes indicates "exchange of information", which indicates that information is exchanged between "elesticsearch-2" and "prometheus-v1".

The device state information 342 includes state information indicating the state of the device 210 configuring the IT system 200. The information included in the device state information 342 can be acquired by, for example, receiving input using the operation input unit 310 or receiving information from an external device such as the device 210 via the communication interface unit 330, and stored in the storage unit 340. The device state information 342 may be updated as necessary in accordance with reception of the state information from the respective devices 210 included in the IT system 200.

In the device state information 342, information for identifying the device 210 included in the IT system 200 can be associated with state information of the corresponding device 210. The device state information 342 may include information indicating the time of acquisition of the state information by each of the devices 210. As described above, the state information can include metrics data, message logs, and so forth. Moreover, the metrics data may include at least some of the CPU usage rate, the RAM usage rate, the amount of transferred data, the amount of received data, the disk usage rate, and the power consumption. Thus, the device state information 342 can include multiple types of data items such as CPU usage rate, RAM usage rate, and message log.

The arithmetic processing unit 350 includes an arithmetic logic unit such as a CPU and a peripheral circuit thereof. The arithmetic processing unit 350 reads the program 343 from the storage unit 340 and executes it, thereby making the above hardware and the program 343 cooperate and implementing various processing units. Main processing units implemented by the arithmetic processing unit 350 are, for example, an error message acquiring unit 351, a configuration information acquiring unit 352, a state information acquiring unit 353, a first question sentence generating unit 354, a first question responding unit 355, a second question sentence generating unit 356, a second question responding unit 357, and an output unit 358.

The arithmetic processing unit 350 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The error message acquiring unit 351 acquires an error message from the IT system 200. The error message acquiring unit 351 may acquire an error message from the device 210 included in the IT system 200.

The configuration information acquiring unit 352 acquires configuration information indicating the configuration of the IT system 200 with reference to the system configuration information 341. For example, the configuration information acquiring unit 352 acquires configuration information through acquisition of an error message by the error message acquiring unit 351. The configuration information acquiring unit 352 may use an error message when acquiring configuration information.

For example, the configuration information acquiring unit 352 acquires configuration information by extraction of a knowledge graph included by the system configuration information 341. Further, the configuration information acquiring unit 352 may acquire configuration information by extracting part of the entire knowledge graph included by the system configuration information 341 by using the source of an error message such as the transmission source of the error message. For example, the configuration information acquiring unit 352 can acquire the configuration information by extracting a component within a predetermined number of pops from a component that is the source of an error message. The number of pops to be the extraction condition may be determined in any manner.

The state information acquiring unit 353 acquires state information indicating the state of the device 210 configuring the IT system with reference to the device state information 342. For example, the state information acquiring unit 353 acquires state information through acquisition of an error message by the error message acquiring unit 351. The state information acquiring unit 353 may acquire state information after acquisition of the configuration information by the configuration information acquiring unit 352. Moreover, the state information acquiring unit 353 may use an error message when acquiring the state information.

For example, the state information acquiring unit 353 can acquire all information included in the device state information 342, as the state information. Moreover, the state information acquiring unit 353 may acquire the state information by extracting part of the information included in the device state information 342 by using the occurrence time of an error indicated by the error message, or the like. For example, the state information acquiring unit 353 can acquire information indicating a state at the past time closest to the occurrence time of the error indicated by the error message, from among the information included in the device state information 342. The state information acquiring unit 353 may acquire information indicating the state for a predetermined period back from the occurrence time of the error with reference to the device state information 342.

The state information acquiring unit 353 may acquire, regarding the metrics data, a predetermined statistical value within an acquisition target period. The statistical value may be at least one of the average value, the minimum value, the maximum value, and so forth. Further, the state information acquiring unit 353 may aggregate, regarding the log messages, the occurrence numbers of conforming log messages for each log template defined in advance, thereby acquiring the templates and the aggregated numbers. Thus, the state information acquiring unit 353 may acquire, regarding the metrics data and log messages, values aggregated by corresponding methods, respectively.

Further, as described above, there is a case of acquiring the configuration information by extracting part of the entire knowledge graph. In such a case, the state information acquiring unit 353 may acquire state information corresponding to the device 210 included in the acquired configuration information. Thus, the state information acquiring unit 353 may acquire the state information using the configuration information acquired by the configuration information acquiring unit 352.

Further, the state information acquiring unit 353 may be configured to acquire the state information from the acquisition target device 210, instead of referring to the device state information 342, or along with referring to the device state information 342. For example, the state information acquiring unit 353 may instruct the acquisition target device 210 to transmit the state information.

The first question sentence generating unit 354 and the first question responding unit 355 function as a partial configuration information acquiring unit that acquires partial configuration information indicating part of the configuration of the IT system shown by the configuration information, in accordance with the error message, the configuration information, and the state information. For example, the first question sentence generating unit 354 generates a first question sentence to be input into a large-scale language model (LLM) by using the error message, the configuration information, and the state information. Further, the first question responding unit 355 acquires partial configuration information by inputting the generated first question sentence into the LLM to acquire a response from the LLM.

FIG. 4 shows the overview of a first question sentence generated by the first question sentence generating unit 354. Referring to FIG. 4, the first question sentence generating unit 354 generates a first question sentence including at least an instruction statement, a conditional statement, the configuration state information and the like, by using the error message, the configuration information, and the state information.

Referring to FIG. 4, an instruction statement can include a description to output a subgraph including a configuration part to be a candidate for failure cause from the configuration information to be input. Further, an instruction statement can include a description to include nodes and edges indicating a relation between components to be candidates for failure cause into the subgraph to be output, and to output the subgraph based on a relation between the components and the status of each resource, and the like. Further, a conditional statement can include constraints such as the constraint for the output subgraph to be in the format of knowledge graph and the upper limit on the number of nodes of the output subgraph. Further, the configuration state information may include a description representing information included in the knowledge graph shown by the configuration information and the state information in text. For example, in the configuration state information, a knowledge graph and the like may be expressed using JSON (JavaScript Object Notation) format or the like.

For example, the first question sentence generating unit 354 may generate the instruction statement and conditional statement described above by referring to information stored in advance. Further, the first question sentence generating unit 354 can generate the configuration state information by referring to the configuration information and the state information to make the nodes as components, and expressing graph structure data in which the respective nodes have the state information as attribute data, in text.

As shown in FIG. 4, an error message may be included in the configuration state information. An error message may be included in an instruction statement, instead of included in the configuration state information. The first question sentence generating unit 354 may include a description indicating the details of an error and a failure indicated by an error message in an instruction statement, instead of including the error message itself in the configuration state information. For example, in a case where the location of a node where the error message has occurred is not known, it may be difficult to include the error message in the configuration state information. In the above case, the first question sentence generating unit 354 may include a description indicating the details of the error and the like in the instruction statement.

The first question responding unit 355 acquires partial configuration information by inputting the generated first question sentence into the LLM and obtaining a response from the LLM. For example, the first question responding unit 355 can acquire a subgraph including part of a knowledge graph as partial configuration information, by inputting the first question sentence as shown above into the LLM. In other words, the first question responding unit 355 can acquire a subgraph to be a configuration part effective for identifying a failure cause of the configuration indicated by the knowledge graph, by inputting the first question sentence into the LLM.

The second question sentence generating unit 356 and the second question responding unit 357 function as a candidate information acquiring unit that acquires information indicating a candidate for failure cause in accordance with partial configuration information and information indicating the state of a device corresponding to the configuration indicated by the partial configuration information. For example, the second question sentence generating unit 356 refers to partial configuration information and identifies information indicating the state of the device 210 corresponding to a configuration indicated by the partial configuration information of the state information. Then, the second question sentence generating unit 356 generates a second question sentence to be input into an LLM by using the partial configuration information and the identified information indicating the state of the device 210. Further, the second question responding unit 357 acquires candidate information that is information indicating a candidate for failure cause by inputting the generated second question sentence into the LLM and obtaining a response from the LLM. The LLM used by the partial configuration information acquiring unit and the LLM used by the candidate information acquiring unit may be the same or may be different.

FIG. 5 shows the overview of a second question sentence generated by the second question sentence generating unit 356. Referring to FIG. 5, the second question sentence generating unit 356 generates a second question sentence including at least an instruction statement, configuration state information corresponding to a subgraph, and so forth, using partial configuration information and so forth.

Here, the instruction statement included in the second question sentence can include a description to extract and present a predetermined number of components anticipated to be the cause of an error, to present the reason for the extraction, and so forth. Further, the configuration state information corresponding to the subgraph may include, not only the configuration information and state information corresponding to the subgraph, but also an error message and information indicating the details of a failure (error) as additional information.

For example, the second question sentence generating unit 356 may generate the instruction statement described above by referring to information stored in advance. Further, the second question sentence generating unit 356 may generate the configuration state information corresponding to the subgraph by referring to partial configuration information and configuration state information.

The second question responding unit 357 acquires candidate information that is information indicating a candidate for failure cause by inputting the generated second question sentence into the LLM and obtaining a response from the LLM. For example, the candidate information can include a predetermined number of causal components, their likelihood, and the reasons for recommendation. FIG. 6 shows an example of the candidate information acquired by the second question responding unit 357. Referring to FIG. 6, the second question responding unit 357 can acquire information indicating candidates for failure cause in a ranking format as the candidate information. Further, the candidate information can include, for each candidate for failure cause, the reason for the ranking assigned. For example, in the case of FIG. 6, the candidate information presents components from the most likely to be the cause of error to the third most likely, along with the reasons why they are more likely.

The output unit 358 outputs the candidate information acquired by the second question responding unit 357, and so forth. The output unit 358 may display the candidate information and so forth on the screen display unit 320 or transmit to an external device via the communication interface unit 330.

For example, the output unit 358 can output the candidate information indicating the causes of error in the ranking format as shown in FIG. 6. Further, the output unit 358 may output information other than that illustrated above. For example, the output unit 358 can output configuration information such as a knowledge graph, state information, and partial configuration information such as a subgraph. The output unit 358 may output the candidate information and so forth superimposed on information indicating the configuration of the IT system 200, such as a knowledge graph and a subgraph. Moreover, the output unit 358 may output the first question sentence, the second question sentence, and the like. The output unit 358 can output at least part of the various types of information illustrated above.

The above is a configuration example of the failure cause identification apparatus 300. Subsequently, an operation example of the failure cause identification apparatus 300 will be described with reference to FIG. 7. FIG. 7 shows an example of the operation of the failure cause identification apparatus 300, and the operation of the failure cause identification apparatus 300 is not limited to the example illustrated in FIG. 7.

FIG. 7 is a flowchart showing an example of the operation of the failure cause identification apparatus 300. Referring to FIG. 7, the error message acquiring unit 351 acquires an error message from the IT system 200 (step S101).

The configuration information acquiring unit 352 acquires configuration information indicating the configuration of the IT system 200 by referring to the system configuration information 341 (step S102). The configuration information acquiring unit 352 may use the error message when acquiring configuration information.

The state information acquiring unit 353 acquires state information indicating the state of the device 210 configuring the IT system, for example, by referring to the device state information 342 (step S103). The state information acquiring unit 353 may use the error message, the configuration information and so forth when acquiring state information.

The first question sentence generating unit 354 generates a first question sentence to be input into a large-scale language model (LLM) using the error message, the configuration information, and the state information (step S104).

The first question responding unit 355 acquires partial configuration information by inputting the generated first question sentence into the LLM and obtaining a response from the LLM (step S105). The first question responding unit 355 can acquire a subgraph including part of a knowledge graph as partial configuration information.

The second question sentence generating unit 356 identifies information indicating the state of the device 210 corresponding to a configuration indicated by the partial configuration information of the state information, with reference to the partial configuration information. Then, the second question sentence generating unit 356 generates a second question sentence to be input into an LLM using the partial configuration information and the identified information indicating the state of the device 210 (step S106).

The second question responding unit 357 acquires candidate information that is information indicating a candidate for failure cause by inputting the generated second question sentence into the LLM and obtaining a response from the LLM (step S107). The second question responding unit 357 can acquire, as the candidate information, information indicating candidates for failure cause in a ranking format, and so forth.

The output unit 358 outputs the candidate information acquired by the second question responding unit 357, and so forth (step S108). The output unit 358 may output at least part of the configuration information such as the knowledge graph, the state information, and the partial configuration information such as the subgraph, in addition to the information illustrated above. Moreover, the output unit 358 may output the first question sentence, the second question sentence, and the like.

The above is an example of the operation of the failure cause identification apparatus 300.

Thus, the failure cause identification apparatus 300 includes the error message acquiring unit 351, the configuration information acquiring unit 352, the state information acquiring unit 353, and a partial configuration information acquiring unit including the first question sentence generating unit 354 and the first question responding unit 355. According to such a configuration, the partial configuration information acquiring unit can acquire the partial configuration information using the error message, the configuration information, and the state information. As a result, the failure cause identification apparatus 300 can appropriately extract a part of configuration information that is effective for identifying the failure cause. In other words, the failure cause identification apparatus 300 can appropriately narrow down the scope of investigation, for example, when identifying a candidate for failure cause.

Further, the failure cause identification apparatus 300 includes a candidate information acquiring unit including the second question sentence generating unit 356 and the second question responding unit 357. According to such a configuration, the candidate information acquiring unit can acquire candidate information using partial configuration information. As a result, the failure cause identification apparatus 300 can identify a candidate for failure cause from the appropriately narrowed scope of investigation. Consequently, the failure cause identification apparatus 300 can more appropriately identify a candidate for failure cause.

For example, it was verified whether the scope of investigation can be narrowed down appropriately by the failure cause identification apparatus 300 described in the present disclosure with respect to a pseudo failure (Noisy Neighbor) in a small-scale microservice. Further, a candidate for failure cause was identified by the failure cause identification apparatus 300 using the narrowed partial configuration information. FIG. 8 shows an example of a configuration of the verified service. FIG. 8 illustrates a case where an error message was transmitted from "elasticsearch-3" and the actual failure cause was "prometheus-v1". Further, in this system, the number of nodes was 39 and the number of edges was 99.

In the abovementioned situation, partial configuration information was acquired using the failure cause identification apparatus 300. FIG. 9 shows an example of configuration state information included in a first question sentence generated by the first question sentence generating unit 354 in the configuration illustrated in FIG. 8. Further, FIG. 10 shows an example of output from an LLM acquired by the first question responding unit 355. That is to say, FIGS. 9 and 10 show that the first question responding unit 355 was able to obtain the output as shown in FIG. 10 from LLM using the first question sentence including the configuration state information as illustrated in FIG. 9. Referring to FIG. 10, it can be seen that in the partial configuration information acquired by the first question responding unit 355, it was able to narrow down to a subgraph including "elasticsearch-3" and "prometheus-v1" and having 7 nodes and 13 edges.

Further, a second question sentence was generated by the second question sentence generating unit 356 using the partial configuration information described above. FIG. 11 shows an example of the second question sentence generated by the second question sentence generating unit 356. In the example shown in FIG. 11, the second question sentence includes the partial configuration information described above and also includes a description to output three causal system components. Further, the second question sentence illustrated in FIG. 11 includes an error message as additional information.

FIG. 12 shows an example of candidate information acquired by the second question responding unit 357 using the second question sentence illustrated in FIG. 11. Referring to FIG. 12, it can be seen that "prometheus-v1", which is the actual failure cause, was estimated as a first candidate.

For example, as illustrated above, it can be seen that the scope of investigation was approximately narrowed down using the failure cause identification apparatus 300 described in the present disclosure. Further, it can be seen that, by using the failure cause identification apparatus 300 described in the present disclosure, a candidate for failure cause was identified appropriately.

### Second Example Embodiment

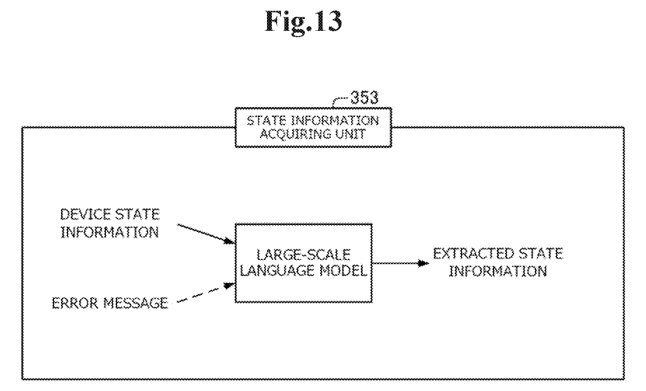

Subsequently, a modified example of the state information acquiring unit 353 described in the first example embodiment will be described with reference to FIG. 13.

As described in the first example embodiment, the device state information 342 can include multiple types of data items. The state information acquiring unit 353 may acquire extracted state information obtained by extracting part of the multiple types of data items, as the state information.

For example, referring to FIG. 13, the state information acquiring unit 353 can acquire extracted state information including some data items of the multiple types of data items by inputting a question sentence including information included in the device state information 342 into an LLM. For example, as described above, the state information acquiring unit 353 may extract some of the multiple types of data items using an LLM or the like. The state information acquiring unit 353 may acquire the extracted state information by inputting an error message or the like into the LLM, in addition to the device state information 342. Moreover, the state information acquiring unit 353 may acquire the extracted state information without using an LLM, for example, may acquire the extracted state information based on rules by using an error message or the like.

### Third Example Embodiment

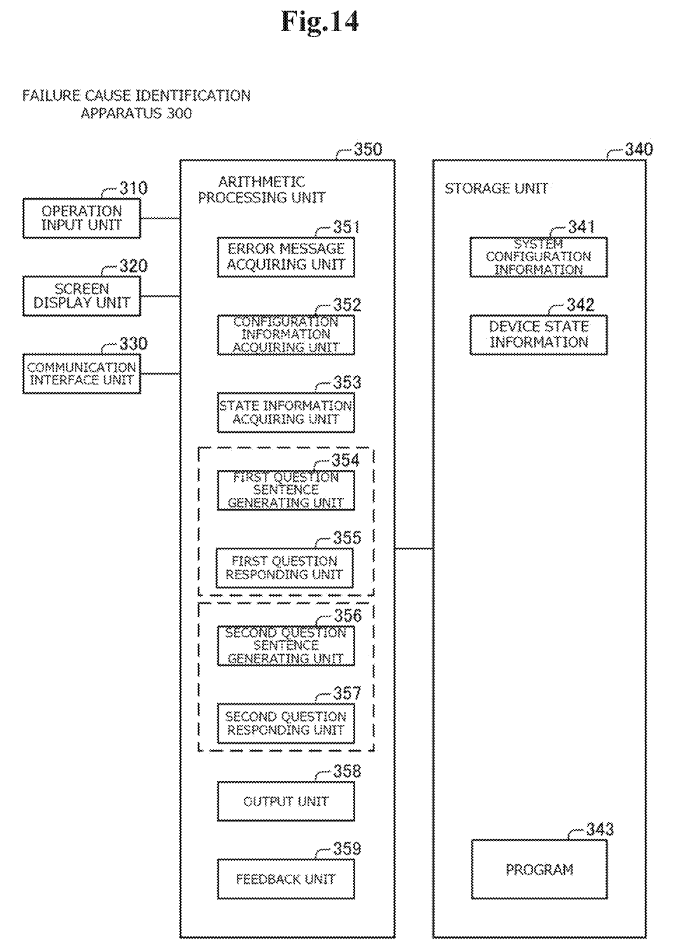

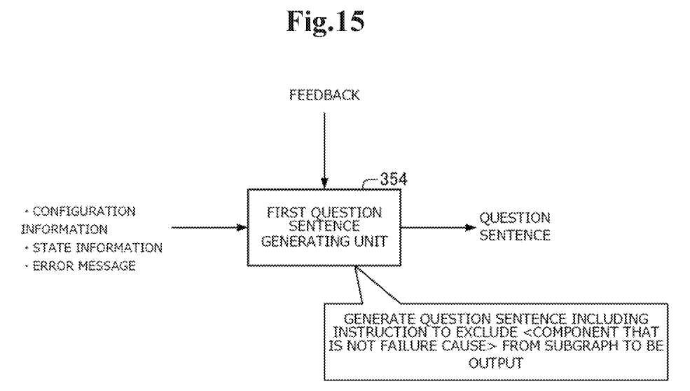

Subsequently, a modified example of the failure cause identification apparatus 300 described in the first example embodiment will be described with reference to FIGS. 14 and 15. In the first example embodiment, the configuration example of the failure cause identification apparatus 300 has been described with reference to FIG. 2. However, the configuration of the failure cause identification apparatus 300 is not limited to the example illustrated in FIG. 2.

For example, FIG. 14 shows another configuration example of the failure cause identification apparatus 300. Referring to FIG. 14, the arithmetic processing unit 350 of the failure cause identification apparatus 300 can have a feedback unit 359 in addition to the configuration illustrated in FIG. 2, by loading and executing the program 343.

The feedback unit 359 feeds back a candidate for failure cause indicated by candidate information acquired by the second question responding unit 357, to the first question sentence generating unit 354 and the like. FIG. 15 shows an example of feedback by the feedback unit 359. Referring to FIG. 15, the first question sentence generating unit 354 can generate a first question sentence with reference to feedback information in addition to an error message, configuration information, and state information, by the feedback unit 359 providing feedback. Consequently, for example, the first question sentence generating unit 354 can generate a first question sentence including an instruction and a constraint that exclude a component that is not the failure cause from a subgraph to be output. As a result, the failure cause identification apparatus 300 can acquire more appropriate partial configuration information by acquiring partial configuration information using the first question sentence generated again.

The feedback unit 359 may be configured to perform feedback to the first question responding unit 355 and the second question sentence generating unit 356, instead of feedback to the first question sentence generating unit 354. Also in such a configuration, the first question responding unit 355 and the second question sentence generating unit 356 may perform the exclusion process corresponding to the feedback.

### Fourth Example Embodiment

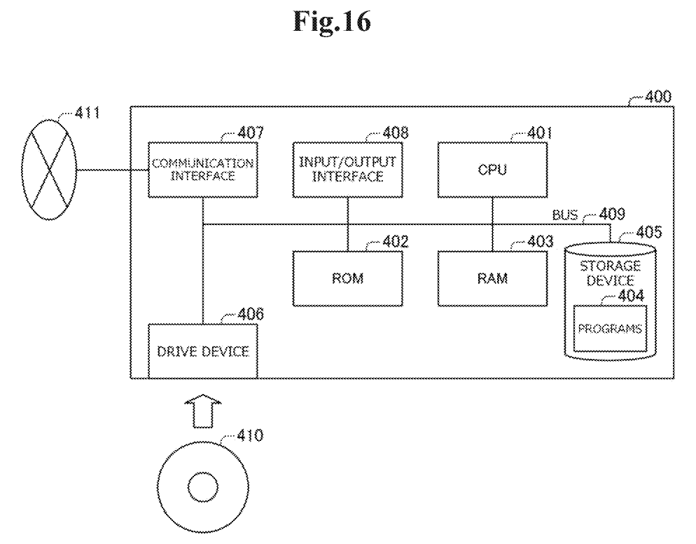

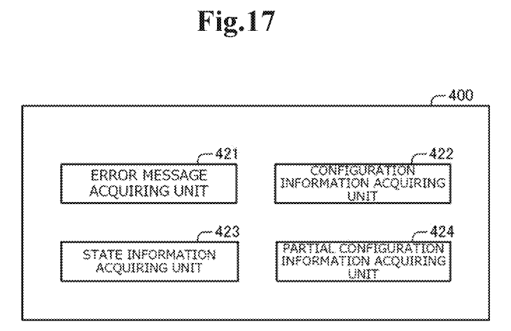

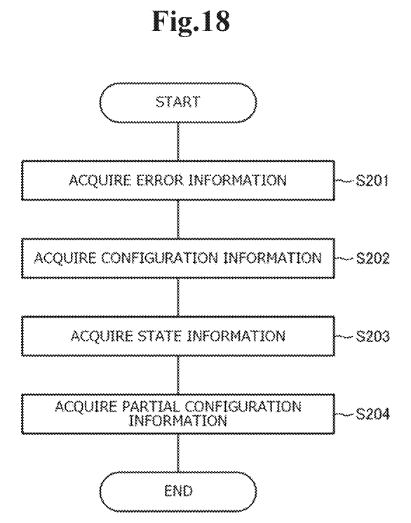

Next, an information processing apparatus 400, which is another modified example of the failure cause identification apparatus 300, will be described with reference to FIGS. 16 to 18. FIG. 16 is a diagram showing an example of a hardware configuration of the information processing apparatus 400. FIG. 17 is a block diagram showing an example of a configuration of the information processing apparatus 400. FIG. 18 is a flowchart showing an example of operation of the information processing apparatus 400.

The information processing apparatus 400 is an information processing apparatus that narrows down a configuration indicated by configuration information using an error message acquired from the IT system 200. FIG. 16 shows a hardware configuration example of the information processing apparatus 400. Referring to FIG. 16, the information processing apparatus 400 has, as an example, the following hardware configuration including:

a CPU (Central Processing Unit) 401 (arithmetic logic unit);

a ROM (Read Only Memory) 402 (memory unit);

a RAM (Random Access Memory) 403 (memory unit);

programs 404 loaded into the RAM 403;

a storage device 405 storing the programs 404;

a drive device 406 that performs reading from and writing into a recording medium 410 external to the information processing apparatus 400;

a communication interface 407 connected to a communication network 411 external to the information processing apparatus 400;

an input/output interface 408 that performs input/output of data; and

a bus 409 connecting the components.

Further, the information processing apparatus 400 can implement functions as an error message acquiring unit 421, a configuration information acquiring unit 422, a state information acquiring unit 423, and a partial configuration information acquiring unit 424 shown in FIG. 17 by acquisition and execution of the programs 404 by the CPU 401. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance in the recording medium 410 and read out by the drive device 406 and provided to the CPU 401.

FIG. 16 shows a hardware configuration example of the information processing apparatus 400. The hardware configuration of the information processing apparatus 400 is not limited to the above example. For example, the information processing apparatus 400 may be configured with part of the abovementioned configuration, such as not having the drive device 406. Moreover, the CPU 401 may be a GPU or the like illustrated in the first example embodiment.

The error message acquiring unit 421 acquires an error message from the IT system 200. The error message acquiring unit 421 may acquire an error message from the device 210 included by the IT system 200.

The configuration information acquiring unit 422 acquires configuration information indicating the configuration of the IT system 200. The configuration information acquiring unit 422 can acquire the configuration information, for example, with reference to information stored in advance. Moreover, the configuration information acquiring unit 422 may use an error message when acquiring the configuration information.

The state information acquiring unit 423 acquires state information indicating the state of the device 210 configuring the IT system 200. The state information acquiring unit 423 can acquire the state information by, for example, referring to information stored in advance or acquiring information from the device 210. Moreover, the state information acquiring unit 423 may use at least one of the error message and the configuration information when acquiring the state information.

The partial configuration information acquiring unit 424 acquires partial configuration information indicating part of the configuration of the IT system 200 indicated by the configuration information in accordance with the error message, the configuration information, and the state information. The partial configuration information acquiring unit 424 may acquire the partial configuration information by inputting the error message, the configuration information, and the state information into an LLM or the like. Further, for example, when acquiring a knowledge graph indicating the configuration of the IT system 200 as the configuration information, the partial configuration information acquiring unit 424 may acquire a subgraph including part of the knowledge graph as the partial configuration information.

The above is an example of the configuration of the information processing apparatus 400. Subsequently, an example of operation of the information processing apparatus 400 will be described with reference to FIG. 18.

FIG. 18 is a flowchart showing an example of the operation of the information processing apparatus 400. Referring to FIG. 18, the error message acquiring unit 421 acquires an error message from the IT system 200 (step S201).

The configuration information acquiring unit 422 acquires configuration information indicating the configuration of the IT system 200 (step S202).

The state information acquiring unit 423 acquires state information indicating the state of the device 210 configuring the IT system 200 (step S203).

The partial configuration information acquiring unit 424 acquires partial configuration information indicating part of the configuration of the IT system 200 shown by the configuration information, in accordance with the error message, the configuration information, and the state information (step S204).

Thus, the information processing apparatus 400 includes the error message acquiring unit 421, the configuration information acquiring unit 422, the state information acquiring unit 423, and the partial configuration information acquiring unit 424. According to such a configuration, the partial configuration information acquiring unit 424 can acquire the partial configuration information in accordance with the error message, the configuration information, and the state information. As a result, the information processing apparatus 400 can appropriately extract a part of the configuration information that is effective for identifying a failure cause. In other words, the information processing apparatus 400 can appropriately narrow down the scope of investigation, for example, when identifying a candidate for failure cause.

The information processing apparatus 400 described above can be implemented by incorporating a predetermined program into an apparatus such as the information processing apparatus 400. To be specific, a program as another aspect of the present disclosure is a program for causing an apparatus such as the information processing apparatus 400 to enable processes to: acquire an error message from an IT system; acquire configuration information indicating the configuration of the IT system; acquire state information indicating the state of a device configuring the IT system; and acquire partial configuration information indicating part of the configuration of the IT system indicated by the configuration information, in accordance with the error message, the configuration information, and the state information.

Further, an information processing method executed by an apparatus such as the information processing apparatus 400 described above is a method by which the apparatus such as the information processing apparatus 400 acquires an error message from an IT system, acquires configuration information indicating the configuration of the IT system, acquires state information indicating the state of a device configuring the IT system, and acquires partial configuration information indicating part of the configuration of the IT system indicated by the configuration information in accordance with the error message, the configuration information, and the state information.

When a program, a computer-readable recording medium storing the program, or an information processing method has the above configuration, the object of the present disclosure described above can be achieved because the same action and effect as that of the information processing apparatus 400 described above are exerted.

### Supplementary Notes

The whole or part of the example embodiments disclosed above can be described as the following supplementary notes. Hereinafter, the overview of an information processing apparatus and so forth in the present disclosure will be described. However, the present disclosure is not limited to the following configurations.

### Supplementary Note 1

An information processing apparatus comprising:

an error message acquiring unit configured to acquire an error message from an IT system;

a configuration information acquiring unit configured to acquire configuration information indicating a configuration of the IT system;

a state information acquiring unit configured to acquire state information indicating a state of a device configuring the IT system; and

a partial configuration information acquiring unit configured to acquire partial configuration information indicating part of the configuration of the IT system indicated by the configuration information in accordance with the error message, the configuration information, and the state information.

### Supplementary Note 2

The information processing apparatus according to supplementary note 1, further comprising

a candidate information acquiring unit configured to acquire information indicating a candidate for error cause in accordance with the partial configuration information and information indicating the state of the device corresponding to the configuration indicated by the partial configuration information.

### Supplementary Note 3

The information processing apparatus according to supplementary note 1 or 2, wherein:

the configuration information acquiring unit is configured to acquire a knowledge graph indicating the configuration of the IT system as the configuration information; and

the partial configuration information acquiring unit is configured to acquire a subgraph

including part of the knowledge graph as the partial configuration information.

### Supplementary Note 4

The information processing apparatus according to any one of supplementary notes 1 to 3, wherein:

the state information includes information indicating a plurality of types of states; and

the partial configuration information acquiring unit is configured to acquire the partial configuration information in accordance with the error message, the configuration information, and extracted state information obtained by extracting part of the information of the plurality of types included by the state information.

### Supplementary Note 5

The information processing apparatus according to supplementary note 2, further comprising

a feedback unit configured to feed back the information acquired by the candidate information acquiring unit into the partial configuration information acquiring unit, wherein

the partial configuration information acquiring unit is configured to acquire the partial configuration information using information having been fed back in addition to the error message, the configuration information, and the state information.

### Supplementary Note 6

The information processing apparatus according to any one of supplementary notes 1 to 5, wherein

the partial configuration information acquiring unit is configured to acquire the partial configuration information by inputting the error message, the configuration information, and the

state information into a large-scale language model.

### Supplementary Note 7

The information processing apparatus according to supplementary note 2, wherein

the candidate information acquiring unit is configured to acquire the information indicating the candidate for error cause by inputting the partial configuration information and the information indicating the state of the device corresponding to the configuration indicated by the partial configuration information into a large-scale language model.

### Supplementary Note 8

The information processing apparatus according to supplementary note 1, wherein:

the configuration information acquiring unit is configured to acquire the configuration information using the error message; and

the state information acquiring unit is configured to acquire the state information using the error message and the configuration information.

### Supplementary Note 8-1

The information processing apparatus according to any one of supplementary notes 1 to 8, wherein:

the partial configuration information acquiring unit is configured to acquire the partial configuration information by inputting a question sentence generated from the error message, the configuration information and the state information into a large-scale language model;

the question sentence includes an instruction statement for instructing to generate the partial configuration information, and a device state information statement corresponding to the configuration information and the state information; and

the error message is included in either one of the instruction statement and the device state information statement.

### Supplementary Note 9

An information processing method by an information processing apparatus, the information processing method comprising:

acquiring an error message from an IT (Information Technology) system;

acquiring configuration information indicating a configuration of the IT system;

acquiring state information indicating a state of a device configuring the IT system; and

acquiring partial configuration information indicating part of the configuration of the IT system indicated by the configuration information in accordance with the error message, the configuration information, and the state information.

### Supplementary Note 10

A program comprising instructions for causing an information processing apparatus to enable processes to:

acquire an error message from an IT (Information Technology) system;

acquire configuration information indicating a configuration of the IT system;

acquire state information indicating a state of a device configuring the IT system; and

acquire partial configuration information indicating part of the configuration of the IT system indicated by the configuration information in accordance with the error message, the configuration information, and the state information.

All or some of the configurations described in Supplementary Notes 2 to 8-1 dependent on the information processing apparatus described in Supplementary Note 1 may be dependent on the information processing method described in Supplementary Note 9, a program described in Supplementary Note 10, and the like by the same dependence. Furthermore, within the scope of the example embodiments described above, not limited to Supplementary Notes 9 and 10, some or all of the configurations described in Supplementary Notes may be dependent on various hardware, software, various recording means for recording software, methods, a program, and system.

Further, the program described in the above example embodiment and supplementary notes can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), CD-ROM (Read Only Memory), CD-R, CD-R/W, and semiconductor memory (e.g., mask ROM, PROM (programmable ROM), EPROM (Erasable PROM), flash ROM, RAM (Random Access Memory)). In addition, a program may be provided to a computer by various types of transitory computer-readable medium. Examples of transitory computer-readable medium include electrical signals, optical signals, and electromagnetic waves. The transitory computer-readable medium may provide a program to the computer via a wired communication channel, such as an electric wire and an optical fiber, or a wireless communication channel.

Although the present disclosure has been described above with reference to the above example embodiments, the present disclosure is not limited to the example embodiments described above. The configuration and details of the present disclosure can be changed in a variety of ways that those skilled in the art can understand within the scope of the present disclosure. Each example embodiment can be combined with the other example embodiments as necessary.

### REFERENCE SIGNS LIST

100 failure cause identification system

200 IT system

210 device

300 failure cause identification apparatus

310 operation input unit

320 screen display unit

330 communication interface unit

340 storage unit

341 system configuration information

342 device state information

343 program

350 arithmetic processing unit

351 error message acquiring unit

352 configuration information acquiring unit

352 state information acquiring unit

354 first question sentence generating unit

355 first question responding unit

356 second question sentence generating unit

357 second question responding unit

358 output unit

359 feedback unit

400 information processing apparatus

401 CPU

402 ROM

403 RAM

404 programs

405 storage device

406 drive device

407 communication interface

408 input/output interface

409 bus

410 recording medium

411 communication network

421 error message acquiring unit

422 configuration information acquiring unit

423 state information acquiring unit

424 partial configuration information acquiring unit

1. An information processing apparatus comprising:
at least one memory storing processing instructions; and
at least one processor configured to execute the processing instructions, wherein the at least one processor is configured to execute the processing instructions to:
acquire an error message from an IT (Information Technology) system;
acquire configuration information indicating a configuration of the IT system;
acquire state information indicating a state of a device configuring the IT system; and
acquire partial configuration information indicating part of the configuration of the IT system indicated by the configuration information in accordance with the error message, the configuration information, and the state information.

2. The information processing apparatus according to claim 1, wherein the at least one processor is configured to execute the processing instructions to
acquire information indicating a candidate for error cause in accordance with the partial configuration information and information indicating the state of the device corresponding to the configuration indicated by the partial configuration information.

3. The information processing apparatus according to claim 1, wherein the at least one processor is configured to execute the processing instructions to:
acquire a knowledge graph indicating the configuration of the IT system as the configuration information; and
acquire a subgraph including part of the knowledge graph as the partial configuration information.

4. The information processing apparatus according to claim 1, wherein:
the state information includes information indicating a plurality of types of states; and
the at least one processor is configured to execute the processing instructions to acquire the partial configuration information in accordance with the error message, the configuration information, and extracted state information obtained by extracting part of the information of the plurality of types included by the state information.

5. The information processing apparatus according to claim 2, wherein the at least one processor is configured to execute the processing instructions to
acquire the partial configuration information using information having been fed back in addition to the error message, the configuration information, and the state information.

6. The information processing apparatus according to claim 1, wherein the at least one processor is configured to execute the processing instructions to
acquire the partial configuration information by inputting the error message, the configuration information, and the state information into a large-scale language model.

7. The information processing apparatus according to claim 2, wherein the at least one processor is configured to execute the processing instructions to
acquire the information indicating the candidate for error cause by inputting the partial configuration information and the information indicating the state of the device corresponding to the configuration indicated by the partial configuration information into a large-scale language model.

8. The information processing apparatus according to claim 1, wherein the at least one processor is configured to execute the processing instructions to:
acquire the configuration information using the error message; and
acquire the state information using the error message and the configuration information.

9. An information processing method by an information processing apparatus, the information processing method comprising:
acquiring an error message from an IT (Information Technology) system;
acquiring configuration information indicating a configuration of the IT system;
acquiring state information indicating a state of a device configuring the IT system; and
acquiring partial configuration information indicating part of the configuration of the IT system indicated by the configuration information in accordance with the error message, the configuration information, and the state information.

10. A non-transitory computer-readable recording medium with a program recorded thereon, the program comprising instructions for causing an information processing apparatus to enable processes to:
acquire an error message from an IT (Information Technology) system;
acquire configuration information indicating a configuration of the IT system;
acquire state information indicating a state of a device configuring the IT system; and
acquire partial configuration information indicating part of the configuration of the IT system indicated by the configuration information in accordance with the error message, the configuration information, and the state information.
